(19) United States
(12) Patent Application Publication
(10) Pub. No.: US 2006/0104182 A1
(43) Pub. Date: May 18, 2006

(54) Optical pickup head and information recording and/or reproducing device incorporating same

(75) Inventor: Wen-Hsin Sun, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/081,952

(22) Filed: Mar. 16, 2005

(30) Foreign Application Priority Data
Nov. 5, 2004 (TW) 93133745

(51) Int. Cl. G11B 7/00

(52) U.S. Cl. 369/112.01; 369/44.37

(57) ABSTRACT

An optical pickup head for an information recording and/or reproducing device compatible with two types of optical recording media is provided. The pickup head includes a first light source (1a) emitting a first wavelength beam, a second light source (1b) emitting a second wavelength beam, a photo detector (2) receiving the first and second beams, a hologram unit deviating the first and second beams onto the receiving member, a prism (4), a collimating lens (50) for collimating at least one of the first and second beams into a parallel beam, and an objective lens (60) for focusing the two beams to the two types of optical recording media respectively. The prism unit includes first and second portions for transmitting the first and second beams, a third portion for transmitting both the first and second beams, and an aberration-correcting portion for one of the first and second beams to pass therethrough.

### FIELD OF THE INVENTION

The present invention generally relates to an optical pickup head and an information recording and/or reproducing device using the optical pickup head, the device being able to record information on and/or reproduce recorded information from plural types of optical recording media.

### PRIOR ART

Optical disks such as CDs (compact disks) and DVDs (digital versatile disks) have been used as information recording media for some time now. Recently, in order to satisfy ongoing requirements for recording and/or reproducing large quantities of information, optical disks with a memory capacity of more than 20 GB have been developed and utilized. The higher recording density of such optical disks requires that a focused spot of laser light generated by an information recording and/or reproducing device must be small and highly accurate. In general, the size of the focused spot (S) is proportional to the wavelength (λ) of the light, and inversely proportional to the numerical aperture (NA) of a lens that focuses the light, as expressed by the following formula (1):
S∝λ/NA (1)

It can be seen from formula (1) that a short wavelength and a large NA are used to obtain a smaller sized light beam spot. For instance, an optical pickup for accessing a CD uses a light beam with a wavelength of 780 nm and an objective lens with an NA of 0.45, whereas an optical pickup for accessing a DVD uses a light beam with a wavelength of 650 nm and an objective lens with an NA of 0.6. A standard for a next generation of high density optical disks has been proposed. The standard specifies that an objective lens has an NA of 0.85, and that light beams with a wavelength of about 405 nm are used.

However, increasing the NA of an objective lens leads to sharp increases in coma aberration, a phenomenon which occurs when an optical disk is tilted. Coma aberration in turn leads to poor quality light convergence to the focused spot. Coma aberration caused by tilting of the optical disk is proportional to a thickness of an optical transmissive layer which is between a light entering plane and an information recording plane of the optical disk. Accordingly, increases in coma aberration caused by increasing the NA can be controlled by reducing the thickness of the optical transmissive layer. This approach forms the basis of a current proposal to reduce the thickness of the optical transmissive layer of next generation high density optical disks from 0.6 mm to 0.1 mm.

In using next generation high density optical disks, the first consideration is the compatibility of corresponding equipment with existing optical disks. Stated differently, a recording and/or reproducing device for next generation high density optical disks should also be capable of recording and/or reproducing data on DVDs which are now in widespread use. However, as indicated above, there are many differences between the two types of disks. This makes it difficult to ensure compatibility of equipment with both types of disks.

One solution to the above problem is exemplified in an optical pickup head described in Japan Patent No. JP10-320815. Referring to FIG. 2, an operational principle of the conventional optical pickup head is illustrated. The optical pickup head (not labeled) includes a first semiconductor laser 801 with a wavelength of 780 nm in a vertical direction, and a second semiconductor laser 802 with a wavelength of 650 nm in a horizontal direction. A laser beam emitted from the first semiconductor laser 801 passes through a hologram element 811, and is converted into a parallel beam by a first collimating lens 803. The parallel beam passes through a wavelength deflection filter 809, and is focused by an objective lens 805 to form a focused laser spot on a CD. The CD reflects the incident beam and provides a return beam including information signals. The return beam sequentially passes through the objective lens 805, the wavelength deflection filter 809 and the first collimating lens 803, and then enters the hologram element 811. The hologram element 811 divides the return beam to be received by first detectors 813.

On the other hand, for recording and/or reproducing with respect to a DVD, the second semiconductor laser 802 emits a laser beam with a wavelength of 650 nm. The laser beam is converted into a parallel laser beam by a second collimating lens 804 disposed beside the second semiconductor laser 802. The parallel laser beam passes through a splitter 807 and a ¼ wavelength plate 808. Subsequently, the parallel laser beam is reflected by the wavelength deflection filter 809, so as to be focused on the DVD by the objective lens 805. The laser beam reflected from the DVD sequentially passes through the objective lens 805 and the wavelength deflection filter 809, and enters the ¼ wavelength plate 808. The polarization direction of the beam is changed by the ¼ wavelength plate 808. Therefore, the laser beam is reflected by the splitter 807, and then is converged by a third collimating lens 810. The converged laser beam propagates through a cylindrical lens 812, and is detected by a second detector 814.

The above-described optical pickup head needs numerous optical components, such as the two separate semiconductor lasers 801 and 802, the two separate detectors 813 and 814, three collimating lens 803, 804 and 810, the wavelength deflection filter 809, and the ¼ wavelength plate 808. This makes the overall size of a recording and/or reproducing device using such optical pickup head unduly large and costly.

To solve the aforementioned problems, an improved optical pickup head has been developed. The optical pickup head includes a semiconductor laser device, a collimating lens, and an objective lens. The semiconductor laser device integrates two semiconductor lasers and two detectors on a same substrate, the semiconductor lasers having different wavelengths. The semiconductor lasers and the detectors are juxtaposed in a line, with one semiconductor laser adjacent to one detector and corresponding with one type of optical disk. The semiconductor lasers are used for emitting laser beams for a CD and a DVD, respectively. In addition, the substrate is disposed inside a case and is sealed with a hologram element. Two diffraction gratings are formed on the hologram element, each diffracting grating opposite to a corresponding pair of the semiconductor lasers and detectors. A composite prism is disposed beside the two diffraction gratings. The prism includes a reflecting mirror, and a wavelength deflection filter parallel to the reflecting mirror.

When recording and/or reproducing information with respect to a CD, a laser beam with a wavelength of 780 nm is emitted from one of the semiconductor lasers. The laser beam passes through the corresponding diffraction grating formed on the hologram element, and enters the composite prism. In the composite prism, the laser beam is reflected by the reflecting mirror and the wavelength deflection filter successively, and propagates out of the prism. After exiting the prism, the laser beam is converted into a parallel beam by the collimating lens, and is focused on the CD by the objective lens, successively. The laser beam reflected by the CD passes through the objective lens, collimating lens, the prism, the corresponding diffraction grating and the hologram element, and is received by the detector that is beside the semiconductor laser which emitted the laser beam.

When recording and/or reproducing with respect to a DVD, a laser beam with a wavelength of 650 nm is emitted from the other semiconductor laser. The laser beam passes through the corresponding diffraction grating formed on the hologram element and the wavelength deflection filter of the prism, and is converted into a parallel beam by the collimating lens. The parallel beam is converged by the objective lens and focused on the DVD. The laser beam reflected by the DVD passes through the objective lens, the collimating lens, the prism, the corresponding diffraction grating and the hologram element, and is received by the other detector.

This type of optical pickup head reduces the number of optical components and simplifies the overall configuration to a certain extent. However, there is market demand for even more miniaturized optical pickup heads. Furthermore, the optical performance of the optical pickup head is limited. This is because there is only the single common objective lens and the single collimating lens focusing light having the two different wavelengths. Therefore the focusing of the light of one of these wavelengths is subject to chromatic aberration. Moreover, the two types of disks have different thicknesses, including different thicknesses of light transmission layers thereof. Therefore the focusing of the light of either or both wavelengths is subject to spherical aberration. These problems in turn lead to poor quality light convergences to the focused light spot.

### SUMMARY OF THE INVENTION

Accordingly, an object of the present invention is to provide an optical pickup head for an information recording and/or reproducing device compatible with at least two types of optical disks, in which optical aberrations are corrected and a size of the optical pickup head is reduced.

Another object of the present invention is to provide an information recording and/or reproducing device using the above-described optical pickup head.

To achieve the first above-mentioned object, an optical pickup head for a recording and/or reproducing device compatible with two types of optical recording media is provided. The optical pickup head includes a first light source emitting a first beam with a first wavelength, a second light source emitting a second beam with a second wavelength greater than the first wavelength, a receiving member for receiving a return first beam and a return second beam, a hologram unit deviating the first and second beams onto the receiving member, a prism unit, a collimating lens for collimating one of the first and second beams into a parallel beam, and an objective lens for receiving the first and second beams and focusing the first and second beams to the at least two types of optical recording media respectively. The prism unit includes a first portion for transmitting the first beams emitted from the first light source, a second portion for transmitting the second beams emitted from the second light source, a third portion for transmitting both the first and second beams, and an aberration-correcting portion for one of the first and second beams to pass therethrough.

To achieve the second above-mentioned object, an information recording and/or reproducing device includes an optical pickup head as described in the above paragraph, a drive mechanism for changing a relative position between an information storage medium and the optical pickup head, and an electrical signal processor for receiving signals output from the optical pickup head and performing calculations to obtain desired information.

Other objects, advantages and novel features of the present invention will be drawn from the following detailed description of preferred embodiments thereof with the attached drawings, in which:

### BRIEF DESCRIPTION OF THE DRAWINGS

FIG. 1 is an exploded, isometric view of an arrangement of parts of an optical pickup head according to a preferred embodiment of the present invention, also showing essential optical paths thereof; and

FIG. 2 is an exploded, isometric view of an arrangement of parts of a conventional optical pickup head, also showing essential optical paths thereof.

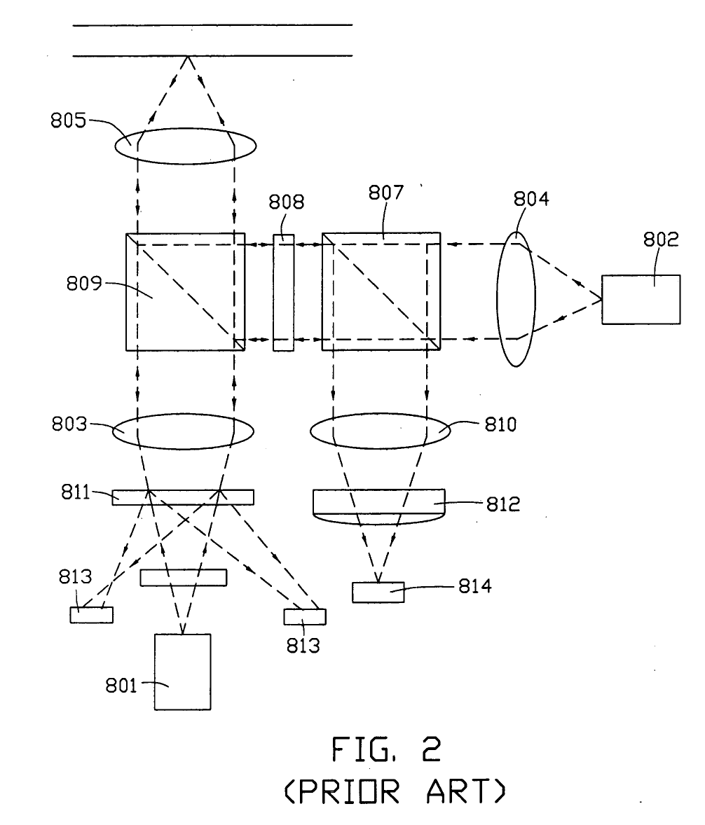

### DETAILED DESCRIPTION OF THE INVENTION

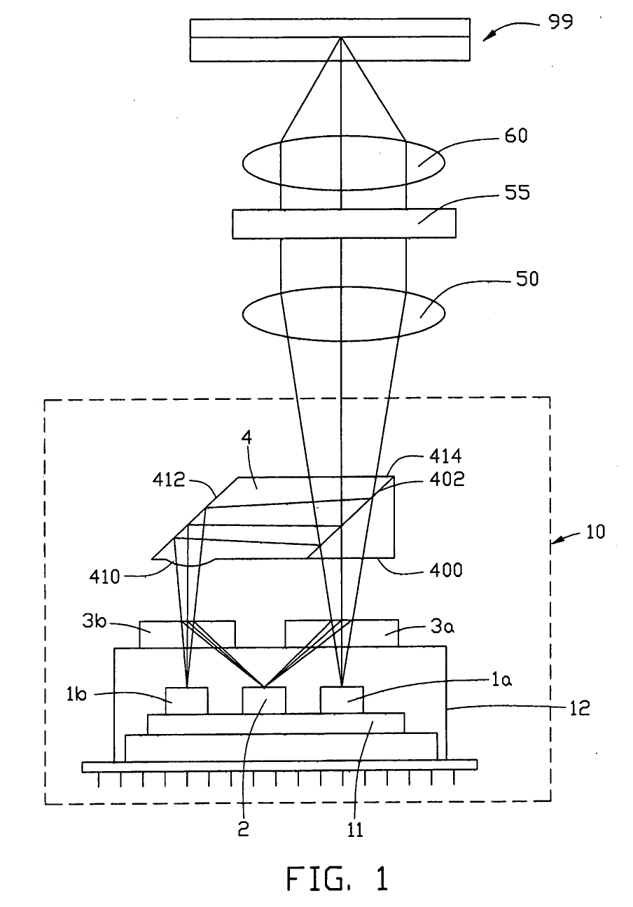

FIG. 1 is a schematic structural view of an optical pickup head (not labeled) according to the preferred embodiment of the present invention. The optical pickup head has a semiconductor laser device 10, a collimating lens 50, a wavelength selector 55, and an objective lens 60 beside the wavelength selector 55. The optical pickup head is used in an information recording and/or reproducing device (not shown), which is compatible with two types of optical disks with different recording densities. Characteristics of the collimating lens 50 and the objective lens 60 are provided to accord with the optical disk having a higher recording density. The wavelength selector 55 selectively propagates an incident beam to the objective lens 60.

The semiconductor laser device 10 includes a substrate 11, first and second semiconductor lasers 1a and 1b disposed on the substrate 11 and juxtaposed with each other, and a photo detector 2 formed integrally with the substrate 11 and abutting the semiconductor lasers 1a and 1b. The photo detector 2 is located between the first and second semiconductor lasers 1a and 1b, so as to enable the optical pickup head to be miniaturized. The first and second semiconductor lasers 1a and 1b generate laser beams with different wavelengths to be employed as irradiation light beams, each wavelength being specified by one type of optical disk. In a typical HD-DVD/DVD compatible player, the laser beams are emitted at two different wavelengths: about 405 nm for an HD-DVD, and about 650 mn for a DVD.

The semiconductor laser device 10 also includes a cover 12 covering the substrate 11 and sealing the first and second semiconductor lasers 1a and 1b and the photo detector 2 therein, first and second hologram elements 3a and 3b juxtaposed on a top plane (not labeled) of the cover 12, and a prism 4 beside the hologram elements 3a and 3b. The first hologram element 3a is opposite to the first semiconductor laser 1a, so as to propagate a laser beam emitted from the first semiconductor laser 1a along its original direction, and to deviate a laser beam returned from the HD-DVD. The second hologram element 3b is opposite to the second semiconductor laser 1b, so as to propagate a laser beam emitted from the second semiconductor lasers 1b along its original direction, and to deviate a laser beam returned from the DVD. Both of the first and second hologram elements 3a and 3b have predetermined pitches and locations, so as to enable the two deviated laser beams having a same focus. The photo detector 2 is located at the focus. That is, the photo detector 2 is a single element receiving laser beams from two different directions.

The prism 4 includes an incident surface (not labeled), an emergent surface 414 parallel to the incident surface, a reflective surface 412 interconnecting the incident surface and the emergent surface 414 at corresponding ends thereof, and an optical path splitting plane 402 parallel to the reflective surface 412 at an opposite side of the prism 4. A first incident portion 400 and an adjacent second incident portion 410 are defined at the incident surface. The first incident portion 400 is opposite to the first hologram element 3a, while the second incident portion 410 is opposite to the second hologram element 3b. An aberration-correcting portion is also formed on the prism 4. The aberration-correcting portion is an aspherical surface or a spherical surface adapted to converge incident light. In the illustrated embodiment, the aberration-correcting portion is an aspherical surface, and is provided at the second incident portion 410. In an alternative embodiment, the aberration-correcting portion can be a spherical surface provided at the second incident portion 410.

When recording an information signal on and/or reproducing an information signal from an optical disk 99 which has the HD-DVD format, the first semiconductor laser 1a emits a first laser beam with the wavelength of 405 nm. The first laser beam passes through the first hologram element 3a along its original direction, and enters the prism 4 through the first incident portion 400. In the prism 4, the first laser beam passes through the optical path splitting plane 402 because of its wavelength, and transmits out from the emergent surface 414. Subsequently, the first laser beam is condensed and transformed into a first parallel beam by the collimating lens 50. The first parallel beam completely passes through the wavelength selector 55 and is incident on the objective lens 60. The objective lens 60 focuses the first parallel beam toward the optical disk 99 to form a focused laser spot (not shown) on an information recording layer (not labeled) of the optical disk 99.

When the focused laser spot is formed on the optical disk 99, the optical disk 99 reflects the focused laser spot so as to form a first return beam having recorded information. The first return beam sequentially passes through the objective lens 60, the wavelength selector 55, the collimating lens 50 and the prism 4, and reaches the first hologram element 3a. The first return beam is deviated by the first hologram element 3a, and received by the photo detector 2. The photo detector 2 translates the first return beam into electrical signals. An electrical signal processor of the information recording and/or reproducing device receives electrical signals output from the optical pickup head, and performs calculations to obtain the desired information. Furthermore, a drive mechanism of the information recording and/or reproducing device changes a relative position between the optical disk 99 and the optical pickup head, also based on the electrical signals output from the optical pickup head.

When recording an information signal on and/or reproducing an information signal from an optical disk 99 which has the DVD format, the second semiconductor laser 1b emits a second laser beam with the wavelength of 650 nm. The second laser beam passes through the second hologram element 3b along its original direction, and enters the prism 4 through the second incident portion 410. The second laser beam is condensed to a certain extent by the second incident portion 410. The second condensed beam is reflected by the optical path splitting plane 402 because of its wavelength, and transmits out from the emergent surface 414. After exiting the prism 4, the second condensed beam is further converged and transformed into an approximately parallel second beam by the collimating lens 50. The approximately parallel second beam transmits to the wavelength selector 55. Only a central part of the approximately parallel second beam can pass through the wavelength selector 55 and be incident on the objective lens 60. The objective lens 60 focuses the incident approximately parallel second beam toward the optical disk 99 to form a focus laser spot (not shown) on an information recording layer (not shown) of the optical disk 99.

When the focused laser spot is formed on the optical disk 99, the optical disk 99 reflects the focused laser spot so as to form a second return beam having recorded information. The second return beam sequentially passes through the objective lens 60, the wavelength selector 55, the collimating lens 50 and the prism 4, and reaches the second hologram element 3b. The second return beam is deviated by the second hologram element 3b, and is received by the photo detector 2. The photo detector 2 translates the second return beams into electrical signals. The electrical signal processor of the information recording and/or reproducing device receives electrical signals output from the optical pickup head, and performs calculations to obtain the desired information. Furthermore, the drive mechanism of the information recording and/or reproducing device changes a relative position between the optical disk 99 and the optical pickup head, also based on the electrical signals output from the optical pickup head.

The optical pickup head provides good performance for both types of optical disks 99. Both (i) the working wavelength of the collimating lens 50 and the objective lens 60, and (ii) the numerical aperture of the objective lens 60, are directly matched with the requirements of the HD-DVD format. Therefore, when recording an information signal on and/or reproducing an information signal from the optical disk 99 having the HD-DVD format, the optical pickup head provides high quality light convergence to the focused light spot. Further, the aberration-correcting portion is provided in the optical pickup head only on the optical path relating to the DVD format laser beams. That is, aberrations caused by non-matching between the second laser beam and the collimating lens 50 and objective lens 60 are corrected. The wavelength selector 55 selects a part of the second laser beam transmitting to the objective lens 60, so that only a central part of the objective lens 60 is illuminated by the second laser beam. Thus the NA of the objective lens 60 is reduced when focusing the second laser beam, and corresponds to the small NA required by the DVD format. Hence, when recording an information signal on and/or reproducing an information signal from the optical disk having the DVD format, the optical pickup head provides high quality light convergence to the focused light spot.

The optical pickup head also has structural and other advantages. Because the second laser beam is reflected between the surfaces of the prism 4, the distance between the collimating lens 50 and the second semiconductor laser 1b is reduced. This enables the optical pickup head to be miniaturized. In addition, the aberration correcting portion is directly formed on the prism 4, so that no extra optical element need be added to the optical pickup head. This further facilitates miniaturization of the optical pickup head, and saves costs and improves the efficiency of mass production.

Furthermore, the two hologram elements 3a and 3b focus the two kinds of return laser beams from different directions onto the same focus. Therefore, only a single photo detector 2 is required. Moreover, the first and second semiconductor lasers 1a and 1b and photo detector 2 are integrated on the same substrate 11. These advantages further facilitate miniaturization of the optical pickup head, savings in costs, and enhanced efficiency of mass production.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. An optical pickup head for an information recording and/or reproducing device compatible with at least two types of optical recording media, comprising:
a first light source emitting a first beam with a first wavelength;
a second light source emitting a second beam with a second wavelength greater than the first wavelength;
a receiving member for receiving a return first beam and a return second beam;
a hologram unit deviating the first and second beams onto the receiving member;
a prism including a first portion for transmitting the first beams emitted from the first light source, a second portion for transmitting the second beams emitted from the second light source, a third portion for transmitting both the first and second beams, and an aberration-correcting portion for one of the first and second beams to pass therethrough;
a collimating lens for collimating at least one of the first and second beams into a parallel beam; and
an objective lens for receiving the first and second beams and focusing the first and second beams to the at least two types of optical recording media respectively.

2. The optical pickup head according to claim 1, wherein the aberration-correcting portion is an aspherical surface.

3. The optical pickup head according to claim 1, wherein the aberration-correcting portion is a spherical surface.

4. The optical pickup head according to claim 1, wherein the prism comprises an incident surface, an emergent surface parallel to the incident surface, a reflective surface interconnecting the incident surface and the emergent surface at corresponding ends thereof, and an optical path splitting plane parallel to the reflective surface at an opposite side of the prism.

5. The optical pickup head according to claim 4, wherein the first portion and second portion are defined at the incident surface.

6. The optical pickup head according to claim 5, wherein the aberration-correcting portion is provided at the second portion.

7. The optical pickup head according to claim 1, wherein the hologram unit comprises a first hologram element facing the first light source and adapted to propagate the first beam, and a second hologram element facing the second light source and adapted to propagate the second beam.

8. The optical pickup head according to claim 1, wherein the first and second light sources and the receiving member are integrated on a same substrate.

9. The optical pickup head according to claim 8, wherein the receiving member is located between the first and second light sources.

10. The optical pickup head according to claim 1, wherein the objective lens includes a numerical aperture specified by one of the at least two types of optical recording media, being that which has the highest recording density.

11. The optical pickup head according to claim 10, further comprising a wavelength selector located between the collimating lens and the objective lens, for selectively passing a portion of the second laser beams.

12. An information recording and reproducing apparatus compatible with at least first and second optical recording media, comprising:
an optical pickup head, comprising:
a first light source emitting a first beam with a first wavelength;
a second light source emitting a second beam with a second wavelength greater than the first wavelength;
a receiving member for receiving a return first beam and a return second beam;
a hologram unit located on an optical path of the first beam and an optical path of the second beam, for deviating return first and second beams onto the receiving member;
a prism including a first portion for transmitting the first beams emitted from the first light source, a second portion for transmitting the second beams emitted from the second light source, a third portion for transmitting both the first and second beams, and an aberration-correcting portion for one of the first and second beams to pass therethrough;
a collimating lens for collimating at least one of the first and second beams into a parallel beam; and
an objective lens for receiving the first and second beams and focusing the first and second beams to the at least two types of optical recording media respectively;
a drive mechanism for changing a relative position between any one of the at least first and second optical recording media and the optical pickup head; and
an electrical signal processor for receiving signals output from the optical pickup head and performing calculations to obtain desired information.

13. The information recording and reproducing apparatus according to claim 12, wherein the aberration-correcting portion is an aspherical surface.

14. The information recording and reproducing apparatus according to claim 12, wherein the prism comprises an incident surface, an emergent surface parallel to the incident surface, a reflective surface interconnecting the incident surface and the emergent surface at corresponding ends thereof, and an optical path splitting plane parallel to the reflective surface at an opposite side of the prism.

15. An information recording and reproducing apparatus compatible with at least a first and a second optical recording media, said apparatus having an optical pickup head to obtain information from a selective one of said first and second optical recording media, said optical pickup head further comprising:
a first light source emitting a first light beam with a first wavelength to said first optical recording media;
a second light source emitting a second light beam with a second wavelength different from said first wavelength to said second optical recording media;
a receiving member for receiving a first return light beam from said first optical recording media and a second return light beam from said first optical recording media respectively in order for subsequently generating said information;
a first hologram element disposed beside said first light source to receive said first light beam and transmit said first light beam to said first optical recording media without substantially changing a course thereof, and to receive said first return light beam from said first optical recording media and deflect said first return light beam toward said receiving member;
a second hologram element disposed beside said second light source to receive said second light beam and transmit said second light beam to said second optical recording media without substantially changing a course thereof, and to receive said second return light beam from said second optical recording media and deflect said second return light beams toward said receiving member; and
an objective lens located next to said selective one of said first and second optical recording media for receiving said first and second light beams and focusing said first and second light beams on said selective one of said first and second optical recording media respectively.

16. The information recording and reproducing apparatus according to claim 15, further comprising a prism disposed between said objective lens and each of said first and second hologram elements to transmit said first and second light beams therebetween.

17. The information recording and reproducing apparatus according to claim 16, wherein an aberration-correcting portion is disposed on said prism for exclusive passage of said second light beam and said second return light beam.

18. The information recording and reproducing apparatus according to claim 17, wherein said aberration-correcting portion is an aspherical surface.

19. The information recording and reproducing apparatus according to claim 15, wherein said first and second light sources and said receiving member are integrated side by side on a substrate with a cover thereon.
